(19) United States
(12) Patent Application Publication
(10) Pub. No.: US 2006/0091123 A1
(43) Pub. Date: May 4, 2006

(54) Method for hydrophilic treatment of a surface of a material

(75) Inventor: Ga-Lane Chen, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 10/975,773

(22) Filed: Oct. 28, 2004

(51) Int. Cl. B23K 26/36

(52) U.S. Cl. 219/121.69

(57) ABSTRACT

A method for hydrophilic treatment of a surface of a material includes the following steps: providing the material having the surface; and applying laser beams produced by a laser source to the surface of the material to form a hydrophilic nanostructure thereat. The nanostructure has a plurality of regular, repeating units. A pitch between adjacent units is in the range from 10 nanometers to 500 nanometers. A height of each unit is in the range from 10 nanometers to 100 nanometers. A surface roughness of the treated material is in the range from 1 nanometer to 10 nanometers. Each unit can be sawtooth-shaped, hump-shaped, square-shaped, step-shaped, or multi-step shaped. Because the nanostructure is directly formed as part of the surface of the material, a contact angle of water droplets is reduced to a small contact angle. Thus, the surface of the material can remain hydrophilic for a long time.

### TECHNOLOGY FIELD

The present invention relates to methods for modifying surfaces of materials to make them easier to maintain, and more particularly to methods for hydrophilic treatment of surfaces.

### BACKGROUND

Commercial detergent formulations can clean public, domestic and industrial hard surfaces efficiently. These formulations generally consist of: an aqueous solution of surfactants, in particular of nonionic and anionic surfactants; and alcohol, to facilitate drying. The formulations may optionally also consist of sequestering agents and bases to adjust the pH. A major defect of these formulations becomes manifest after their use. That is, the surface may subsequently come into contact with water, and when the water drops dry off, marks or stains are left behind on the surface. This contact with water may occur, for example, when dishes are rinsed after washing, when it rains after windows are cleaned, or when bathroom tiles are splashed after cleaning. When dishes are washed by hand, a detergent formulation is used. When dishes are washed by machine, a dishwasher detergent is used. The dishwasher detergent may be used either during the cleaning cycle or during the rinsing cycle.

The leaving of marks or stains on hard surfaces after drying is due to the gradual contraction of the drops of water on the surface as the drops evaporate. The marks or stains left on the surface correspond to the original shapes and dimensions of the drops.

One solution to this problem is to perform hydrophilic treatment on the surface of a material. Hydrophilic treatment is a surface processing technology, which makes the surface of the material hydrophilic. Coating a layer of hydrophilic polymer on the surface of the material is the generally used method to make the material hydrophilic.

U.S. Pat. No. 6,730,366 discloses a process for coating a surface of a material, comprising the steps of: applying one or more different comb-type polymers to the surface, the comb-type polymers comprising a polymer backbone and side chains pendently attached thereto, with at least a part of the side chains carrying a triggerable precursor for carbene or nitrene formation; and fixing the polymer onto the surface using heat or radiation, in particular radiation such as UV (ultraviolet) or visible light. The polymers provide the surface with a useful hydrophilic coating. However, the hydrophilic coating is prone to detach from the surface after a period of time.

Another method to make a material hydrophilic is to coat a layer of surfactant on the surface of the material. The surfactant has hydrophilic groups that collectively provide a contact layer on the surface of the material. The contact layer reduces a contact angle of water droplets to a small contact angle. Thus, the surface of the material is hydrophilic. However, the surfactant is prone to run off in water after a period of time. It is difficult to keep the surface of the material hydrophilic for a long time.

Therefore, a processing method which can make a surface of a material hydrophilic for a long time is desired.

### SUMMARY OF THE INVENTION

An object of the present invention is to provide a method which can make a surface of a material hydrophilic for a long time.

In order to achieve the object set out above, a method for hydrophilic treatment of a surface of a material in accordance with the present invention comprises the following steps: providing the material having the surface; and applying laser beams produced by a laser source to the surface of the material to form a hydrophilic nanostructure thereat. The nanostructure comprises a plurality of regular, repeating units. A pitch between adjacent units is in the range from 10 nanometers to 500 nanometers. A height of each unit is in the range from 10 nanometers to 100 nanometers. A surface roughness of the treated material is in the range from 1 nanometer to 10 nanometers. Each unit can be sawtooth-shaped, hump-shaped, square-shaped, step-shaped, or multi-step shaped. The nanostructure is directly formed as part of the surface of the material, and reduces a contact angle of water droplets to a small contact angle. Thus, the surface of the material can remain hydrophilic for a long time. In addition, the nanostructure is insignificant in size compared with the whole material, which is typically macroscopic in size. Therefore the nanostructure does not change the overall shape of the material, and does not affect the original appearance of the material.

Other objects, advantages and novel features of the present invention will become more apparent from the following detailed description when taken in conjunction with the accompanying drawings, in which:

### BRIEF DESCRIPTION OF THE DRAWINGS

FIG. 1 is a flowchart of a preferred method for hydrophilic treatment of a surface of a material according to a preferred embodiment of the present invention; and

FIG. 2 is a schematic view of a nanostructure formed by the method according to the preferred embodiment of the present invention.

### DETAILED DESCRIPTION OF PREFERRED EMBODIMENTS OF THE INVENTION

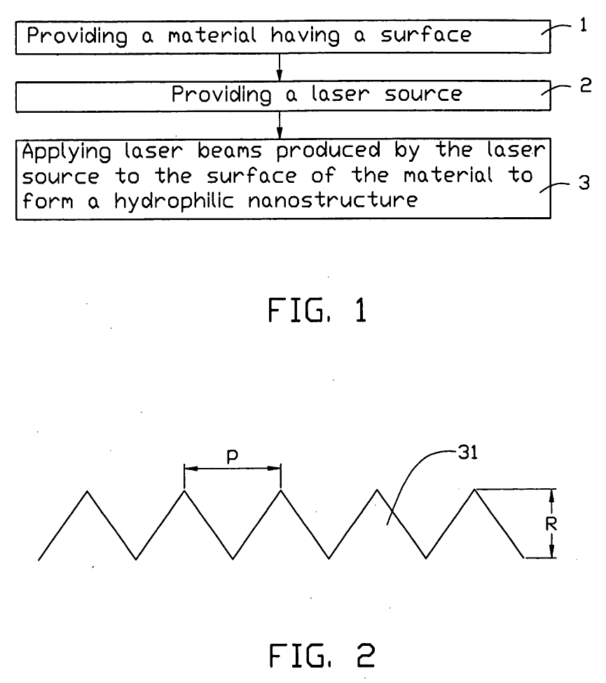

Referring to FIG. 1, a method for hydrophilic treatment of a surface of a working piece with predetermined material according to the preferred embodiment of the present invention comprises the following steps: providing a material having a surface (step 1); providing a laser source (step 2); and applying laser beams produced by the laser source to the surface of the material to form a hydrophilic nanostructure (step 3). In step 1, the material comprises glass, metal or an alloy. The particular laser source employed varies according to the material provided. If the material is glass, a carbon dioxide laser is employed to process the glass surface. If the material is a metal or an alloy, a neodymium doped yttrium aluminum garnet (Nd:YAG) laser is employed to process the metal or alloy surface. Applying the laser beams to the material surface involves well-known laser processing or laser-carving technologies. That is, high-intensity laser beams produced by the laser source are focused on the surface of the material to form a predetermined shape on said surface, all of which is controlled by a computer. The power density of the focused laser beams can be between 10⁷-10¹² watts per square centimeters, and the temperature of said surface can be up to 1×10⁵ degrees Celsius. Accordingly, virtually any glass, metal or alloy material can be fused and vaporized immediately.

FIG. 2 is a schematic view of a nanostructure formed on a surface of a material by performing the method in accordance with the present invention. The nanostructure is a plurality of regular, repeating units. In the preferred embodiment, each unit is a sawtooth-shaped ridge 31. A pitch P between adjacent ridges 31 is in the range from 10 nanometers to 500 nanometers. A height R of each ridge 31 is in the range from 10 nanometers to 100 nanometers. A surface roughness of the material is in the range from 1 nanometer to 10 nanometers.

It will be understood by persons skilled in the art that the nanostructure formed by the method of the present invention is not limited to the sawtooth-shaped ridges 31. The nanostructure can be a plurality of regular, repeating units having other shapes. For example, each unit may be a ridge that is hump-shaped, square-shaped, step-shaped, or multi-step shaped. So long as the pitch P between adjacent units is in the range from 10 nanometers to 500 nanometers, the height R of each unit is in the range from 10 nanometers to 100 nanometers, and the surface roughness of the material is in the range from 1 nanometer to 10 nanometers, the material is hydrophilic.

The nanostructure produced by the present invention is directly formed as part of the surface of the material, which reduces a contact angle of water droplets to a small contact angle. Thus, the surface of the material can remain hydrophilic for a long time. In addition, the nanostructure is insignificant in size compared with the whole material, which is typically macroscopic in size. Therefore the nanostructure does not change the overall shape of the material, and does not affect the original appearance of the material.

It is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method for hydrophilic treatment of a surface of a material, comprising the following steps:
providing the material having the surface; and
applying laser beams produced by a laser source to the surface of the material to form a hydrophilic nanostructure thereat.

2. The method in accordance with claim 1, wherein the nanostructure comprises a plurality of regular, repeating units.

3. The method in accordance with claim 2, wherein a pitch between adjacent units is in the range from 10 nanometers to 500 nanometers.

4. The method in accordance with claim 2, wherein a height of each unit is in the range from 10 nanometers to 100 nanometers.

5. The method in accordance with claim 1, wherein a surface roughness of the treated material is in the range from 1 nanometer to 10 nanometers.

6. The method in accordance with claim 1, wherein the material is selected from the group consisting of glass, metal and an alloy.

7. The method in accordance with claim 2, wherein each unit is sawtooth-shaped, hump-shaped, square-shaped, step-shaped, or multi-step shaped.

8. The method in accordance with claim 1, wherein the laser source is a carbon dioxide laser.

9. The method in accordance with claim 1, wherein the laser source is a neodymium doped yttrium aluminum garnet laser.

10. A method for surface treatment, comprising the steps of:
preparing a surface of a working piece;
selecting a specialized laser source according to conditions of said surface; and
applying laser beams produced by said laser source onto said surface to form a nanostructure thereof.

11. The method in accordance with claim 10, wherein said laser source is a carbon dioxide laser in said conditions that said surface is glass.

12. The method in accordance with claim 10, wherein said laser source is a neodymium doped yttrium aluminum garnet laser in said conditions that said surface is metallic.

13. A method for surface treatment, comprising the following steps:
preparing a surface of a working piece;
selecting a specialized laser source according to conditions of said surface; and
applying laser beams produced by said laser source onto said surface to alter said surface to a hydrophilic condition.

14. The method in accordance with claim 13, wherein a nanostructure is formed on said surface to perform said hydrophilic condition during said applying step.
